(19) United States
(12) Patent Application Publication
(10) Pub. No.: US 2007/0118681 A1
(43) Pub. Date: May 24, 2007

(54) Data write-in method for flash memory

(76) Inventor: Guoping Xiong, Guangdong (CN)

Correspondence Address: LADAS & PARRY LLP, 224 SOUTH MICHIGAN AVENUE, SUITE 1600, CHICAGO, IL, 60604, US

(21) Appl. No.: 10/584,778

(22) PCT Filed: Dec. 14, 2004
(86) PCT No.: PCT/CN04/01446

§ 371 Date: Dec. 27, 2006

(30) Foreign Application Priority Data
Dec. 31, 2003 (CN) 200310117714.2

(51) Int. Cl. G06F 12/00; G06F 12/06

(52) U.S. Cl. 711/103; 711/5

(57) ABSTRACT

The present invention provides a data write-in method of flash memory for writing data into two or more flash chips, the method comprises: firstly correspond the physical blocks in the two flash chips to the odd logical block address and the even logical block address respectively; analyse the logical block address which corresponds to the write-in operation from the data write-in instruction; judge the parity of said logical block address and select the corresponding flash chip according to the result; operate the flash chip, detect whether or not the other flash chip needs to be programmed or erased after direct the instruction to program or erase the flash chip, when the other flash chip needs to be programmed or erased, then direct the program or erase instruction to the other flash chip. Using the method of the present invention can program and erase two flash chips simultaneously, thereby increasing the data write-in speed greatly.

### FIELD

The present invention relates to a data write-in method for flash memory, and more particularly, to a method for writing data into two or more flash chips.

### BACKGROUND

Presently, flash chips have been widely used in mobile storage apparatuses. However, the operating speed of such mobile storage apparatuses is slow due to the defects existing in the intrinsic characteristics and the existing data operating method of flash chips. The storage space of each flash chip (simply referred to as flash chip) is generally divided into multiple blocks (i.e., physical blocks), each composed of multiple pages. According to the read-write characteristics of flash chips, the data write-in operation is performed in a unit of page, while the erase operation can only be performed in a unit of block. Thus, when new data is being written into flash chips or existing data is being modified according to user operations, the old data on the target block (known as “original block” pointed by data writing instruction) must firstly be conveyed to another block (known as “new block”). The new data will then be written on the new block and data on the old block will be erased. Finally, the logic address of the new block will replace the one of the old block. During the whole process, writing and erasing operations are the most time consuming.

The current process of writing operation of flash chips is: 1) writing programming, 2) waiting for the completion of the writing programming, 3) performing the erase operation after the completion of the writing programming, and 4) carrying over the next writing programming again. This method is necessary for one flash chip (the “one” chip described herein is corresponding to one chip select signal; if there are two chip select signals, it is considered as “two” flash chips). Since there is only one chip select signal on one flash chip, two different operations (i.e., programming) cannot be performed simultaneously. However, as for a storage device containing multiple flash chips, the writing operation speed of flash chips may be severely limited if data write-in operation is performed according to the writing operation process described above. Presently, with the increase of the capacity of mobile storage devices, it is an inevitable trend to employ multiple flash chips. Therefore, increase the write-in speed of flash chips becomes crucial in flash memory technology.

### SUMMARY

The object of the present invention is to provide a data write-in method for flash memory. This method will be rid of the disadvantages of the current flash chips data operating technology, such as low operating speed and low efficiency. The data write-in method for flash memory of the present invention is implemented by the following technical schemes.

The said method comprises: the physical blocks in the two flash chips are partitioned into odd logical block addresses and even logical block addresses respectively; the logical block address is then abstracted from write-in method; the parity of the logical block address is found and the corresponding flash chip is selected from the two flash chips accordingly; the physical block corresponding to the logical block address in the selected flash chip is operated; whether the other flash chip needs to be programmed or erased is then detected; finally the programming or erase instruction, if needed, are applied to the other flash chip.

The methods of the present invention make it possible to program or erase one flash chip while programming or erasing the other flash chip, thereby greatly saving the writing operation time and increasing the data write-in speed.

The following specific and detailed description and drawings of the embodiments will help everybody in this field understanding the principal idea of this invention.

### BRIEF DESCRIPTION OF DRAWINGS

FIG. 1 is a schematic diagram showing the distribution of the logical block address corresponding to the physical blocks in the two flash chips in the embodiment of the flash memory data write-in method for the present invention.

FIG. 2 is a schematic diagram showing the main process of the flash memory data write-in method for the present invention.

FIG. 3 is a schematic diagram showing the first process of the flash memory data write-in method for the present invention.

FIG. 4 is a schematic diagram showing the second process of the flash memory data write-in method for the present invention.

### DETAILED DESCRIPTION

A data write-in method for flash memory is provided to increase the speed of writing data into two or more flash chips. The two flash chips refer to flash chips corresponding to two chip select signals, including a flash chip which is physically one flash chip but contains two chip select signals.

This embodiment is described through the example of writing data into a storage apparatus containing two flash chips. The storage apparatus comprises a controller and two flash chips.

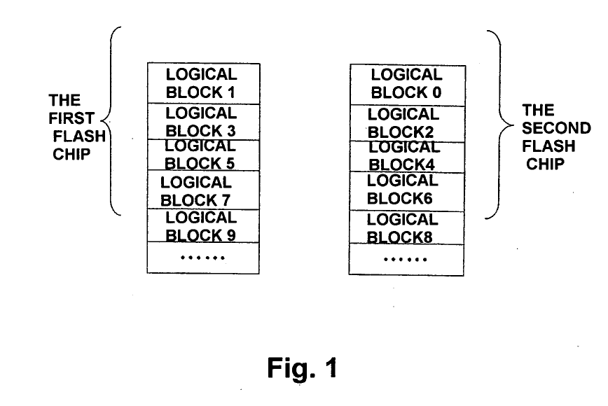

FIG. 1 showed the distribution of the logical block address corresponding to the physical blocks in the two flash chips, which were used in the flash memory data write-in method of the present invention. The physical blocks in the two flash chips were respectively mapped to the odd logical block addresses and the even logical block addresses. The flash chip containing only the odd logical block address was referred to as the first flash chip, while the flash chip containing only the even logical block address was referred to as the second flash chip. The odd logical block addresses of the first flash chip and the even logical block addresses of the second flash chip could be combined into continuous logical block addresses.

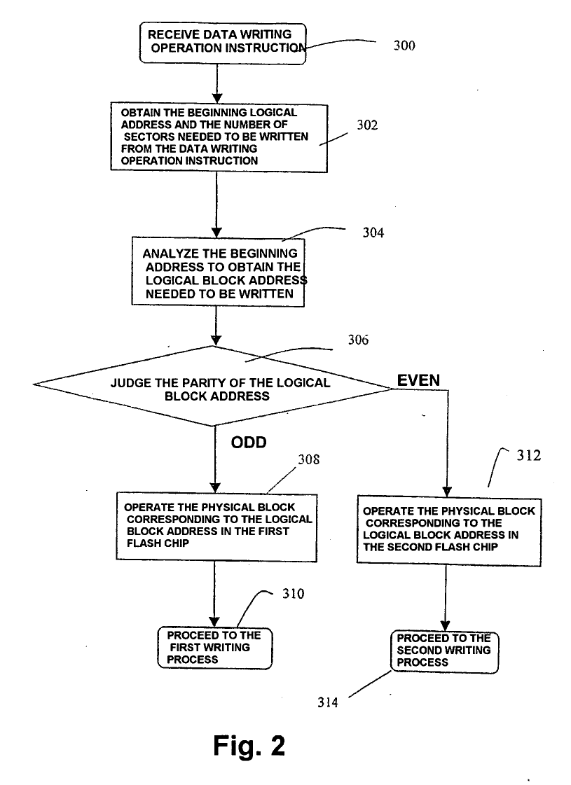

FIG. 2 showed the main process of the present invention. After the data writing operation instruction was received by the controller from the main frame, the following processes took place:

The main process started, i.e. step 300;

The main process then proceeded to step 302 in which the controller obtained the beginning logical address and the number of sectors needed according to the writing operation instruction.

Next, the main process proceeded to step 304 in which the beginning logical address in step 302 was analyzed to obtain the needed logical block address for writing;

Thereafter, the main process proceeded to step 306 in which the parity of the logical block address in step 304 was judged;

If the logical block address was odd, then the main process proceeded to step 308 in which data was written into the physical block corresponding to the logical block address in the first flash chip, then the process proceeded from step 308 to step 310 in which the first writing process was called.

If the logical block address was even, then the main process proceeded to step 312 in which data was written into the physical block corresponding to the logical block address in the second flash chip, then the process proceeded from step 312 to step 314 in which the second writing process was called.

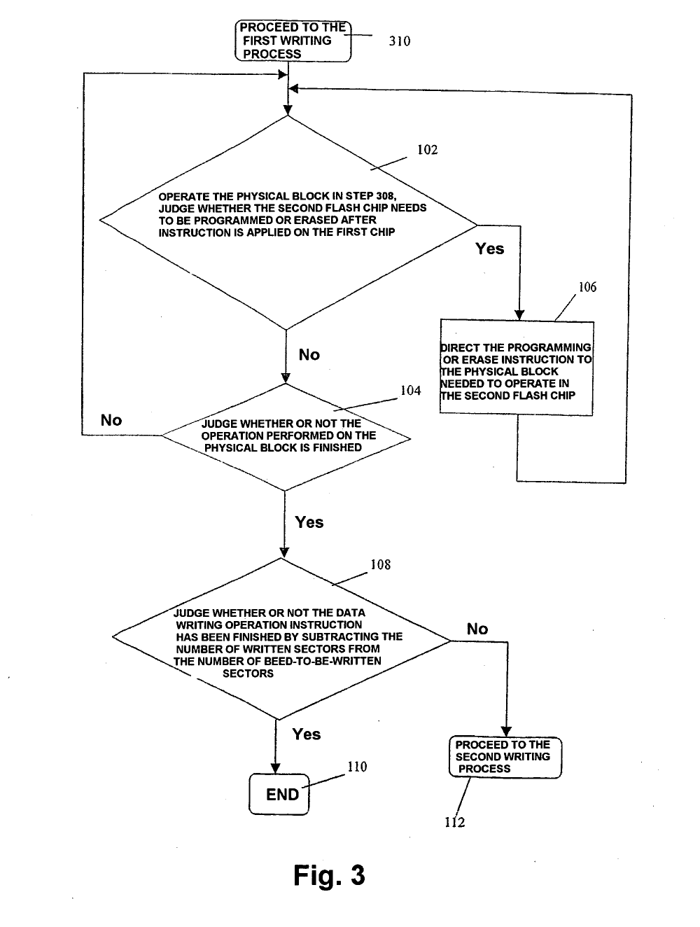

FIG. 3 showed the first process of the flash memory data write-in method for the present invention. The operating process of the present invention proceeded from step 310 of the main process to step 102 of the first writing process.

In step 102, the operations including directing programming and erasing instruction were performed to the physical block in step 308 by the controller. The programming or erase instruction was directed to the physical block until the physical block was to be programmed or erased. Whether the second flash chip needed to be programmed or erased was assessed afterwards.

If the second flash chip needed to be programmed or erased, the first writing process proceeded from step 102 to step 106 in which the controller directed the corresponding instruction to the target physical block on the second flash chip.

If the second flash chip did not need to be erased, the first process proceeded from step 102 to step 104 in which the controller decided whether the operation of the physical block in the first flash chip was finished;

If the operation of the physical block in the first flash chip had not been finished, the first process returned form step 104 to step 102;

If the operation of the physical block in the first flash chip had been finished, the first process proceeded form step 104 to step 108;

In step 108, the controller subtracted the number of the already written sectors from the number of the needed-to-be-written sectors (obtained in step 302), and use the result to decide whether the data writing operation instruction had been finished. If the result was 0, the data writing operation instruction was considered to be finished; if not, the data writing operation instruction was considered to be not finished.

If the data writing operation instruction had been finished, the first process proceeded to step 112 in which the first writing process proceeded to the second writing process.

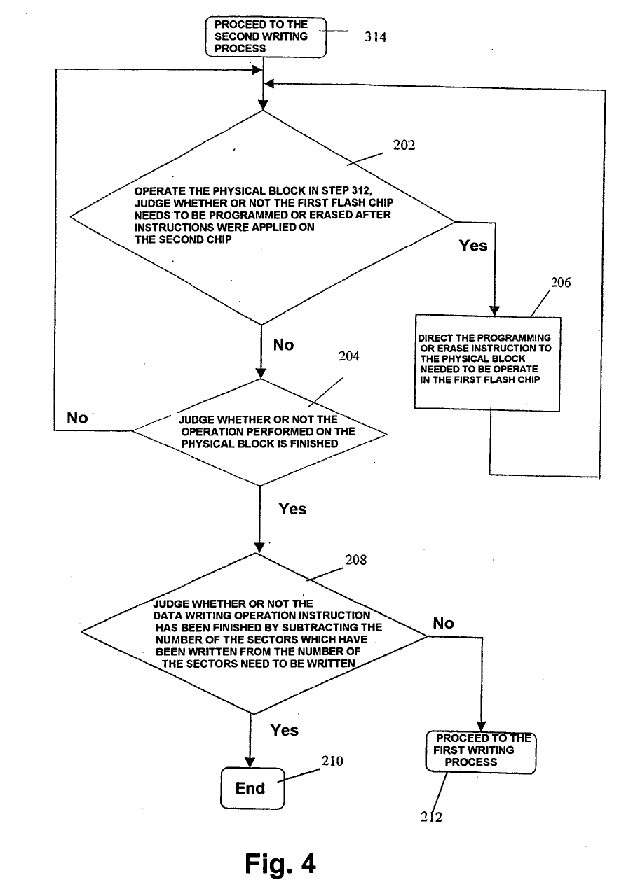

FIG. 4 showed the second process of the method for increasing the data write-in speed of the flash chip in the present invention. The operating process of the present invention proceeded from step 310 of the first writing process to step 202 of the second writing process.

In step 202, the operation was performed to the physical block in step 312 by the controller. The corresponding instruction was directed to the physical block until needed. Whether the first flash chip needed to be programmed or erased was decided afterwards.

If the first flash chip needed to be erased, the first writing process proceeded from step 202 to step 206 in which the needed instruction was directed by the controller to the target physical block of the first flash chip.

If the first flash chip did not need to be erased, the second writing process proceeded from step 202 to step 204 in which the controller decided whether the operation of the physical block in the second flash chip was finished.

If the operation of the physical block in the second flash chip had not been finished, the second writing process returned from step 204 to step 202;

If the operation of the physical block in the second flash chip had been finished, the second writing process proceeded from step 204 to step 208;

In step 208, the controller subtracted the number of the written sectors from the number of the need-to-be-written sectors (obtained in step 302), and decided according to the result whether the data writing operation instruction had been finished. If the result was 0, the data writing operation instruction was decided to have been finished; if not, the data writing operation instruction was decided to have not been finished.

If the data writing operation instruction had been finished, the second writing process proceeded to step 210 which was the end of the whole process.

If the data writing operation instruction has not been finished, the second writing process proceeded to step 212 in which the said first writing process was called.

When multiple flash chips were included in the flash memory apparatus, the physical blocks in each of two flash chips corresponded respectively to odd logical block addresses and even logical block addresses, and the data write-in operation was performed in the unit of two flash chips. The data write-in operating method performed in the two flash chips was the same as the method of the above embodiment.

The description above was merely the preferred embodiment of the present invention. It should be noted that various improvements and modifications could be made without departing from the principle of the present invention. All these improvements and modifications should also be regarded as the protection scope of the present invention.

1. A data write-in method for flash memory, wherein the flash memory comprises at least two flash chips, and the method includes:
a. partitioning the physical blocks in the two flash chips to odd logical block addresses and even logical block addresses, respectively;
b. receiving a data write-in instruction and analyzing the beginning logical address corresponding to the writing operation from the data write-in instruction;
c. obtaining according to the beginning logical address the logical block address needed to be written, deciding the parity of the logical block address needed to be written, and selecting the corresponding flash chip between the two flash chips according to the parity of the logical block address needed to be written;
d. detecting whether the other flash chip needs to be programmed or erased after the programming or erase instruction is directed to the physical block corresponding to the logical block address in the corresponding flash chip;

2. The data write-in method for flash memory according to claim 1, wherein it further comprises the following step:
e. if the other flash chip needs to be programmed or erased, directing programming or erase instruction to the other flash chip.

3. The data write-in method for flash memory according to claim 1, wherein it further comprises the following step:
f. if the other flash chip do not need to be programmed or erased, then judge whether the operation performed to the corresponding physical block in step d is finished.

4. The data write-in method for flash memory according to claim 3, wherein it further comprises: if the operation performed on the corresponding physical block has been finished, judge whether the data write-in instruction has been finished; if the operation performed to the corresponding physical block has not been finished, return to step d.

5. The data write-in method for flash memory according to claim 3, wherein that: if the data write-in instruction has been finished, return to step b; if the data write-in instruction has not been finished, return to step c.

6. The data write-in method for flash memory according to claim 4, wherein that: the step b further comprises obtaining the number of sectors needed to be written from the data writing operation instruction.

7. The data write-in method for flash memory according to claim 6, wherein that: the method further comprises judging whether the data writing operation instruction has been finished by subtracting the number of written sectors from the number of need-to-be-written-sectors.
